(19) United States
(12) Patent Application Publication
(10) Pub. No.: US 2021/0120144 A1
(43) Pub. Date: Apr. 22, 2021

(54) IMAGE FORMING APPARATUS AND RECEPTION NOTIFICATION METHOD

(71) Applicant: SHARP KABUSHIKI KAISHA, Sakai City (JP)

(72) Inventor: SATOSHI TAKAHASHI, Sakai City (JP)

(21) Appl. No.: 17/070,704

(22) Filed: Oct. 14, 2020

(30) Foreign Application Priority Data
Oct. 17, 2019 (JP) 2019-190113

(51) Int. Cl. H04N 1/32

(52) U.S. Cl. CPC H04N 1/32096; H04N 1/32128; H04N 1/3208

(57) ABSTRACT

An image forming apparatus receives a FAX, a FAX processor performs a FAX reception processing, and acquires reception information (step S11). An information generator determines whether there is reception notification setting information (step S12). If there is a notification setting, the information generator proceeds to step S13, and generates reception notification information. An information notification processor transmits the reception information to a chat server via a network on the basis of the notification setting information (step S14). Next, the information notification processor determines reception notification setting information 124 related to image transfer (step S15). If image transfer is enabled, the information notification processor proceeds to step S16, performs an image transfer process, generates document image information, and transmits same to the chat server. The chat server transmits the reception notification information and the document image information to a terminal apparatus as a chat message.

### BACKGROUND OF THE INVENTION

### Field of the Invention

The present invention relates to an image forming apparatus, a terminal apparatus, a reception notification system, a reception notification method, and a program that use a chat application to perform a reception notification and a processing instruction when a FAX document image is received.

### Description of the Background Art

The multifunctional peripheral (MFP), which is an image forming apparatus, has multiple functions such as a copy function, a FAX function, and a scanner function. By illumination of an LED, the MFP can notify a person around the MFP that the message has been received. However, if a person in charge is out, the person in charge cannot immediately know the content of FAX reception by using such a method.

Japanese Unexamined Patent Application Publication No. 2016-40893 discloses a feature wherein a multifunction peripheral (MFP) that has received a FAX transmits FAX reception data to a storage server, and transmits, via a relay server, new FAX information to a notification destination specified on the basis of the information acquired from the storage server.

However, in the invention of Japanese Unexamined Patent Application Publication No. 2016-40893, only the information is transmitted to the user of the notification destination, and the user cannot instruct the subsequent processing. In a mail transmission, the information that has been set is merely unilaterally sent to a set mail address. Even if a FAX received image is transferred to a shared folder, the user cannot perform a processing instruction other than a preset processing.

In addition, even if the user who is the notification destination of the FAX instructs a new processing, it may be necessary to perform a processing to change the setting, but such processing is not easy for an amateur, and when the MFP is away from the user, the user cannot take action.

In view of such circumstances, it is an object of the present invention to provide an image forming apparatus, a reception notification system, a reception notification method, and a program that can perform a reception notification and a processing instruction with the use of a chat application when receiving a FAX.

### SUMMARY OF THE INVENTION

The present invention is an image forming apparatus for notifying a terminal apparatus in a chat format via a chat server that a FAX has been received. The image forming apparatus includes a FAX processor that receives a FAX and acquires reception information, an information generator that generates reception notification information and document image information on a basis of the reception information, and an information notification processor that transmits the reception notification information and the document image information to the chat server to notify the terminal apparatus.

In addition, the present invention is an image forming apparatus for notifying a terminal apparatus in a chat format that a FAX has been received. The image forming apparatus includes a FAX processor that receives a FAX and acquires reception information, an information generator that generates reception notification information and document image information on a basis of the reception information, and a chat processor that transmits the reception notification information and the document image information to the terminal apparatus as a message for a chat.

The present invention is a reception notification method for notifying a terminal apparatus in a chat format via a chat server that an image forming apparatus has received a FAX. The reception notification method includes receiving a FAX and acquiring reception information, generating reception notification information and document image information on a basis of the reception information, and transmitting the reception notification information and the document image information to the chat server to notify the terminal apparatus.

The present invention is a reception notification method for notifying a terminal apparatus in a chat format that an image forming apparatus has received a FAX. The reception notification method includes receiving a FAX and acquiring reception information, generating reception notification information and document image information on a basis of the reception information, and transmitting the reception notification information and the document image information to the terminal apparatus as a message for a chat.

The present invention is a program for causing a computer to execute the reception notification method.

According to the present invention, the user can receive the FAX reception notification by the terminal apparatus 30 through the chat application, and thus the FAX notification is given even when the user is away from the apparatus, and the user can immediately know that he/she has received a FAX. Moreover, the chat application is easy to use and easy to operate, and it is also possible to give a processing instruction from the terminal apparatus to an other apparatus.

### BRIEF DESCRIPTION OF THE DRAWINGS

FIG. 1 is an explanatory diagram illustrating a configuration of a FAX reception notification system according to a first embodiment of the present invention.

FIG. 2 is an explanatory diagram illustrating a configuration of an image forming apparatus according to the first embodiment of the present invention.

FIG. 3 is a block diagram illustrating a configuration of the image forming apparatus according to the first embodiment of the present invention.

FIG. 4 is a block diagram illustrating a configuration of a chat server according to the first embodiment of the present invention.

FIG. 5 is a block diagram illustrating a configuration of a terminal apparatus according to the first embodiment of the present invention.

FIG. 6 is a block diagram illustrating a configuration of a file server according to the first embodiment of the present invention.

FIG. 7 is a flowchart illustrating a reception notification process of the image forming apparatus according to the first embodiment of the present invention.

FIG. 8 is a flowchart illustrating an image transfer process of the image forming apparatus according to the first embodiment of the present invention.

FIG. 9 is a flowchart illustrating a reception notification process of the chat server according to the first embodiment of the present invention.

FIG. 10 is a diagram illustrating a setting screen in the image transfer process of the image forming apparatus according to the first embodiment of the present invention.

FIG. 11 is a diagram illustrating a reception notification screen in the terminal apparatus according to the first embodiment of the present invention.

FIG. 12 is a block diagram illustrating a configuration of an image forming apparatus according to a variation of the first embodiment of the present invention.

FIG. 13 is a block diagram illustrating a configuration of an image forming apparatus according to a second embodiment of the present invention.

FIG. 14 is a sequence diagram illustrating a procedure of a reception notification and a processing instruction to the image forming apparatus according to the second embodiment of the present invention.

FIG. 15 is a diagram illustrating a display screen of a processing instruction to the image forming apparatus of a terminal apparatus according to the second embodiment of the present invention.

FIG. 16 is a sequence diagram illustrating a procedure of a reception notification and a processing instruction to an image forming apparatus according to a third embodiment of the present invention.

FIG. 17 is a diagram illustrating a display screen of a processing instruction to the image forming apparatus of a terminal apparatus according to the third embodiment of the present invention.

FIG. 18 is an explanatory diagram illustrating positions of an image forming apparatus and a terminal apparatus according to a fourth embodiment of the present invention.

FIG. 19 is a block diagram illustrating a configuration of the image forming apparatus according to the fourth embodiment of the present invention.

FIG. 20 is a flowchart illustrating a reception notification process according to the fourth embodiment of the present invention.

FIG. 21 is a sequence diagram illustrating a procedure of reception notification and deletion of document image data in a chat server 20 according to a fifth embodiment of the present invention.

### DESCRIPTION OF THE PREFERRED EMBODIMENTS

Hereinafter, embodiments of the present invention will be described with reference to the accompanying drawings. The following embodiments are an example for describing the present invention, and the technical scope of the invention described in the claims is not limited to the following description.

### First Embodiment

Hereinafter, a first embodiment of the present invention will be described with reference to the accompanying drawings.

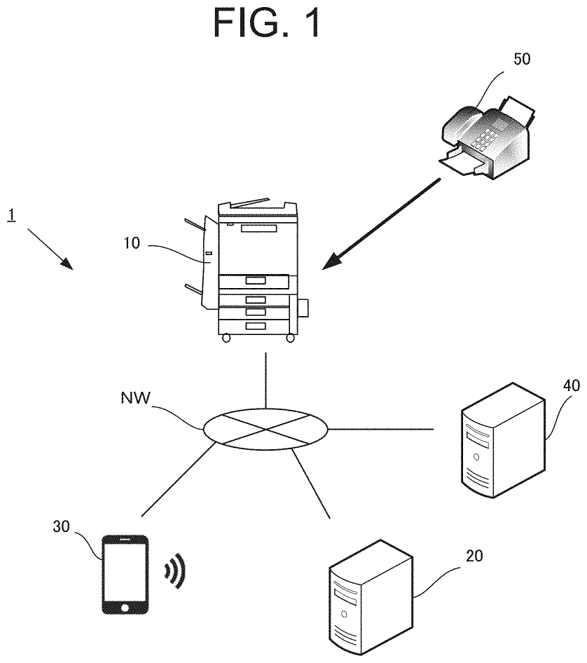

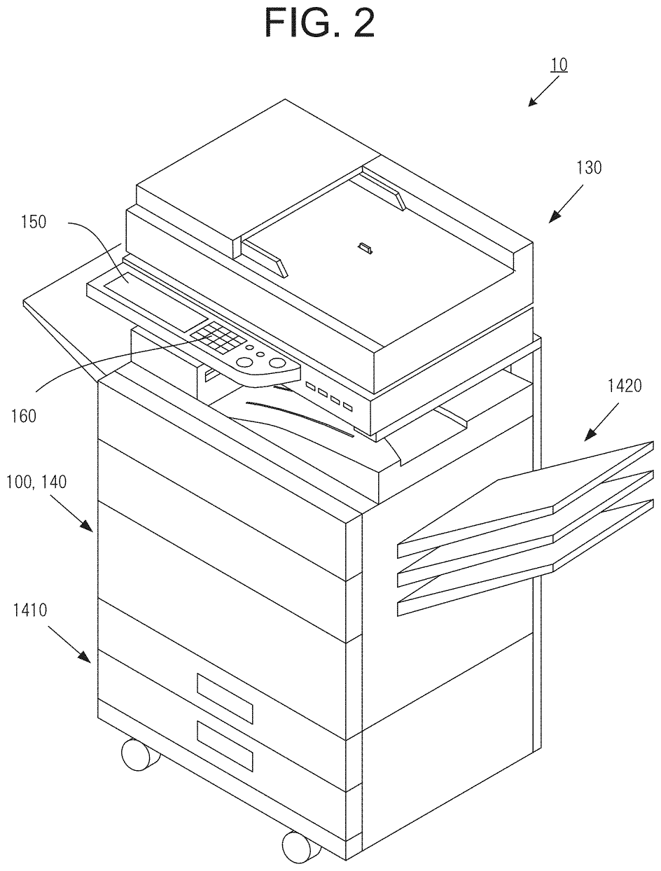

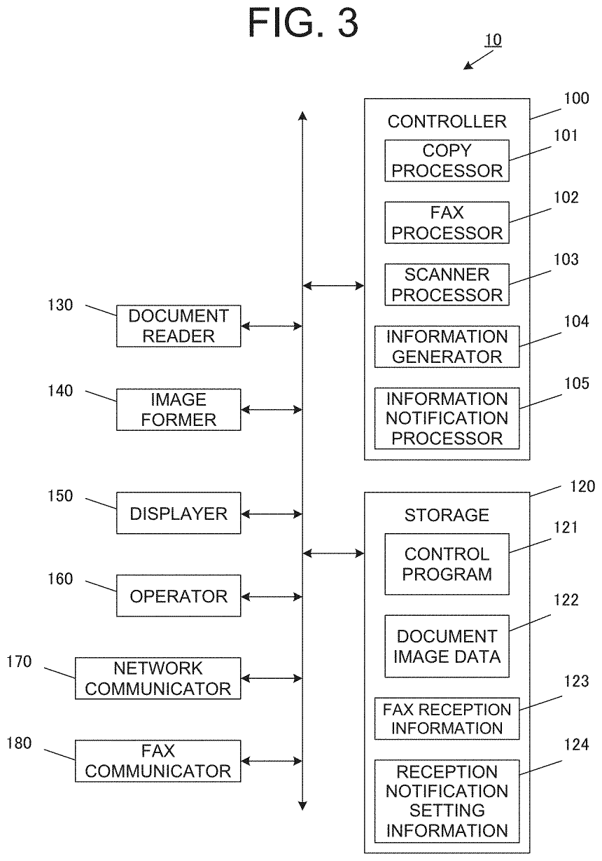

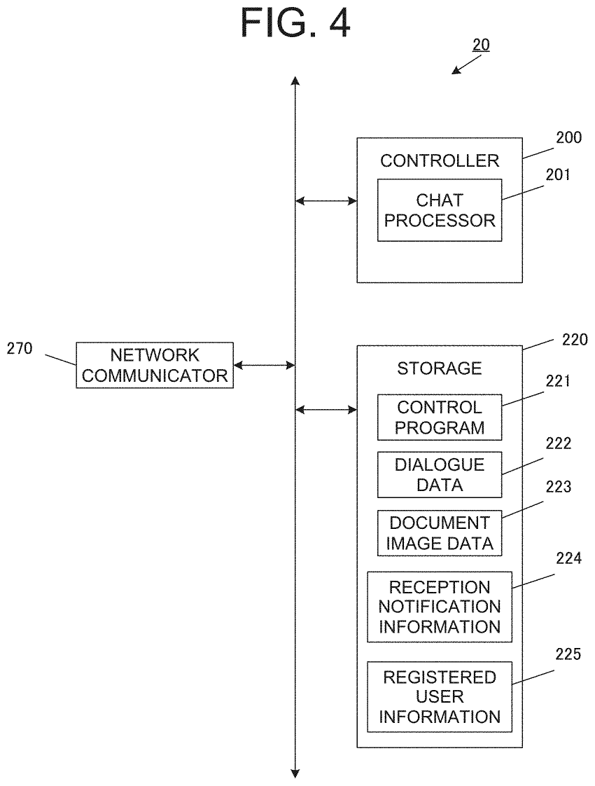

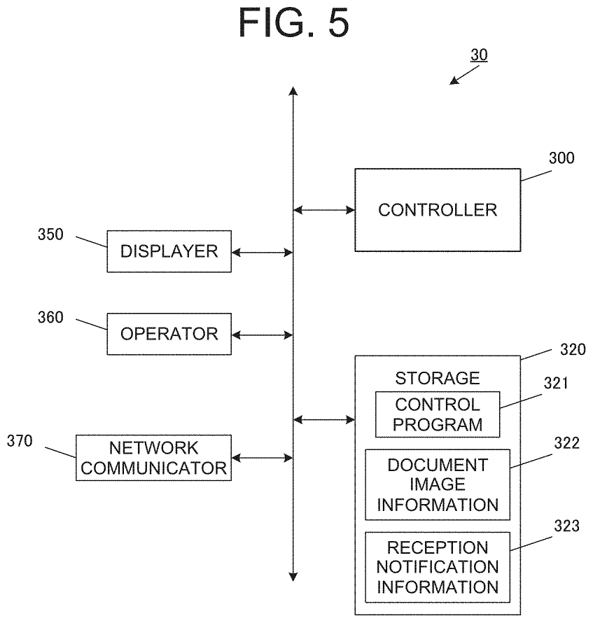

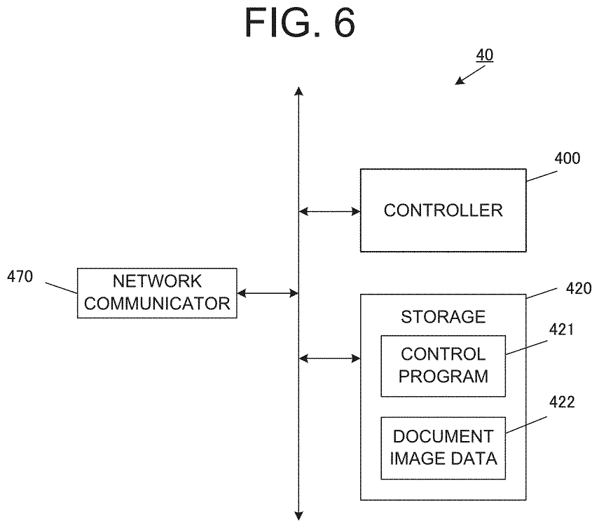

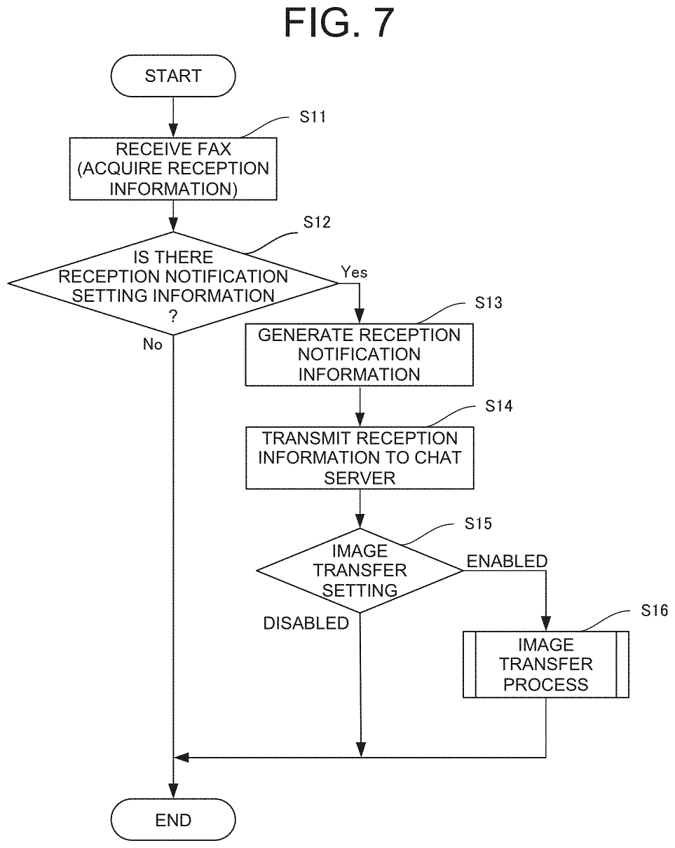

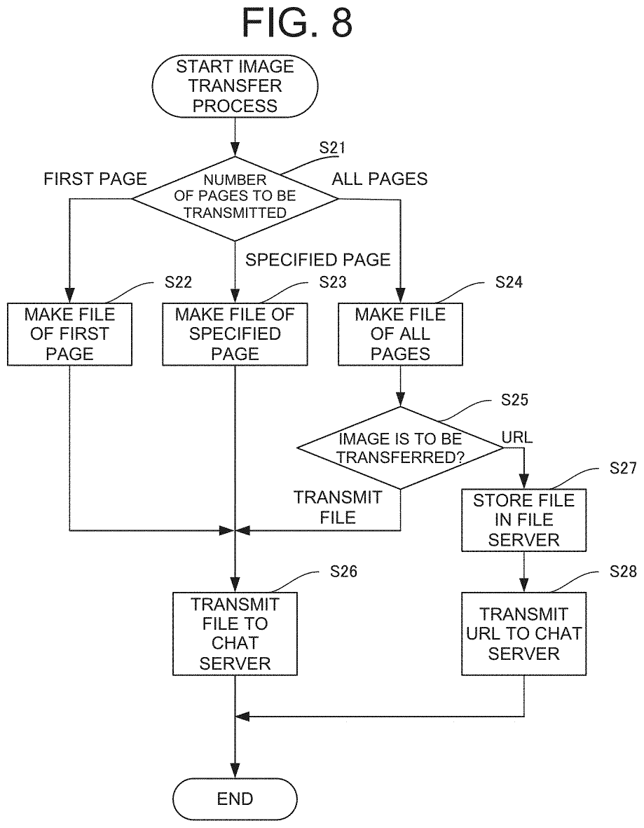

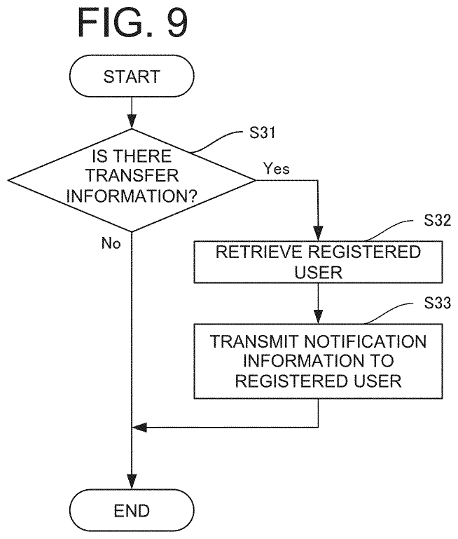

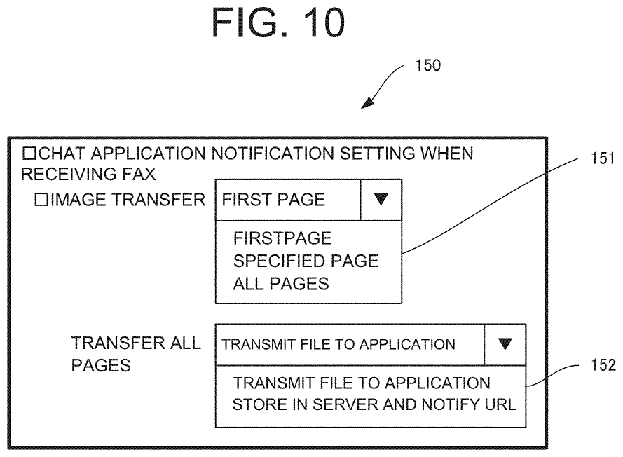

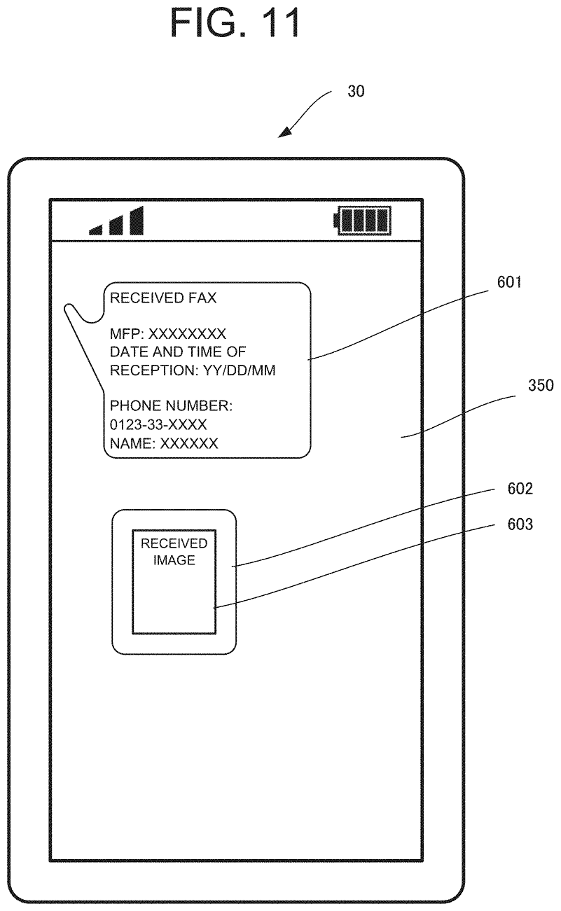

FIG. 1 is an explanatory diagram illustrating a configuration of a FAX reception notification system according to a first embodiment of the present invention. FIG. 2 is an explanatory diagram illustrating a configuration of an image forming apparatus according to the first embodiment of the present invention. FIG. 3 is a block diagram illustrating a configuration of the image forming apparatus. FIG. 4 is a block diagram illustrating a configuration of a chat server according to the first embodiment of the present invention. FIG. 5 is a block diagram illustrating a configuration of a terminal apparatus according to the first embodiment of the present invention. FIG. 6 is a block diagram illustrating a configuration of a file server according to the first embodiment of the present invention. FIG. 7 is a flowchart illustrating a reception notification process of the image forming apparatus. FIG. 8 is a flowchart illustrating an image transfer process of the image forming apparatus. FIG. 9 is a flowchart illustrating a reception notification process of the chat server. FIG. 10 is a diagram illustrating a setting screen in the image transfer process of the image forming apparatus. FIG. 11 is a diagram illustrating a reception notification screen in the terminal apparatus.

### Summary

In the first embodiment, when receiving a FAX from a FAX apparatus 50, an image forming apparatus 10 having a FAX function automatically transmits reception notification information and document image information to a terminal apparatus 30 with the use of a chat application.

### System Configuration

A FAX reception notification system 1 illustrated in FIG. 1 includes an image forming apparatus 10, a chat server 20, a terminal apparatus 30, and a file server 40. The image forming apparatus 10, chat server 20, terminal apparatus 30, and file server 40 are connected via a network (the Internet). The FAX apparatus 50 outside the system and the image forming apparatus 10 are connected by a telephone line and thus a FAX can be transmitted and received. In this embodiment, the FAX apparatus 50 transmits a FAX to the image forming apparatus 10. The image forming apparatus 10 and the FAX apparatus 50 may be connected by a network to transmit and receive a FAX.

### Functional Configuration of Image Forming Apparatus

The image forming apparatus 10 illustrated in FIG. 2 is a multifunction peripheral (MFP) that is disposed in a convenience store or the like, and has multiple modes. The image forming apparatus 10 in this embodiment has the following modes.

The modes of the image forming apparatus 10 are modes that can implement a general copy function, FAX function, and scanner function. When the image forming apparatus 10 is in a copy mode, a copy job can be executed, when in a FAX mode, a FAX job can be executed, and when in a scanner mode, a scanner job can be executed.

The functional configuration of the image forming apparatus 10 will be described in more detail with reference to FIG. 3.

A controller 100 is a functional unit for controlling the entire image forming apparatus 10. The controller 100 implements various functions by reading and executing a control program 121 stored in a storage 120, and includes one or more computing devices (for example, CPUs (Central Processing Units)) or the like. The functions implemented by the controller 100 will be described below.

A copy processor 101 implements a copy function in the copy mode. The copy job performed by the copy processor 101 will be briefly described below.

First, a document is set in a document reader 130 and the copy operation is performed by an operator 160. A user can check, on a displayer 150, a document size, a paper size, and copy settings (for example, single-sided printing, double-sided printing, aggregate printing, etc.) that have been set.

When the user operates the copy start from the operator 160, the copy processing is executed. Specifically, the document reader 130 reads the document set by the user. The controller 100, which will be described later, generates image data from the document read by the document reader 130.

An image former 140 generates an image based on the image data on a paper conveyed from a paper tray 1410 and outputs the paper to a paper output tray 1420. In the present embodiment, the paper is a recording sheet or a recording paper on which an image is formed. The paper includes, not only an ordinary plain paper, but also various paper media such as a thick paper and a glossy paper, and also a film or the like so long as an image can be formed.

A FAX processor 102 implements a FAX function in the FAX mode. The FAX job performed by the FAX processor 102 will be briefly described below.

When transmitting a FAX, the document is set in the document reader 130 and the FAX transmission operation is performed by the operator 160. The user can check, on the displayer 150, a document size and transmission settings (a destination FAX number, etc.) that have been set.

When the user operates the FAX start from the operator 160, the FAX processing is executed. The controller 100, which will be described later, performs a communication procedure with an other party in a FAX communicator 180. Then, when a state where transmission is possible is secured, after performing a necessary processing such as changing the compression format for a compression file, the controller 100 performs sequential transmission to the other party via a communication line.

In addition, when receiving a FAX, the FAX processor 102 acquires FAX reception information and stores same in the storage 120 while performing a communication procedure in the FAX communicator 180. That is, the FAX processor 102 receives a compression file transmitted from the other party, and decompresses the received compression file with a compression/decompression processor (not illustrated). The FAX reception information to be acquired is, for example, telephone information of a number display, a TSI (Transmitting Subscriber Identification Signal), a reception time, the number of documents received, and document image data. Then, if necessary, the image data is subjected to various image processing and output to the image former 140. The image former 140 forms an output image on a recording sheet on the basis of the output image data.

The scanner processor 103 implements a scanner function in the scanner mode. The scanner job performed by the scanner processor 103 will be briefly described below.

First, the document is set in the document reader 130, and the scanner operation is performed by the operator 160. The user can check, on the displayer 150, a document size and output image settings (image file type, etc.) that have been set.

When the user operates the scanner start from the operator 160, the scanner processor 103 executes the scanner processing. Specifically, the document reader 130 reads the document set by the user. The controller 100, which will be described later, generates image data from the document read by the document reader 130.

These functions are executed in a general MFP. Each operation/processing is a known technique, and any known processing may be used so long as it can implement these functions.

An information generator 104 of the controller 100 generates reception notification information and document image information to be notified to the terminal apparatus on the basis of the FAX reception information in the storage 120. The reception notification information is, for example, the identification information (serial number) of the image forming apparatus 10 that has received the FAX, the other party information such as the other party's phone number and the other party's name, the reception time, the number of documents received, and the like. The other party's name is a name in an address book in the storage 120, and is obtained by comparing the other party's phone number and a phone number registered in the address book and determining by a matched phone number in the address book (although the phone number is not illustrated). The document image information is a URL where the filed data or the file of the document image data is saved in accordance with reception notification setting information 124.

When receiving a FAX from the FAX apparatus 50, an information notification processor 105 performs processing for transmitting a reception notification to the terminal apparatus 30 via the chat server 20.

The storage 120 is a functional unit where programs and data are stored. The storage 120 includes, for example, a semiconductor memory such as an SSD (Solid State Drive) and an HDD (Hard Disk Drive).

The storage 120 stores a control program 121, document image data 122, FAX reception information 123, and reception notification setting information 124.

The control program 121 includes an execution control program that controls the processing of each unit.

The document image data 122 is the document image data read by the document reader 130 or document image data received by FAX.

The FAX reception information 123 is the data when the FAX is received, and is acquired by the FAX processor 102 as described above.

The reception notification setting information 124 is information on the setting content for performing a notification, such as notification destination registration information for notification of FAX reception, and page information of the document image to be notified. These pieces of setting information are input in advance by displaying the setting screen on the displayer 150 and using the operator 160.

The document reader 130 reads an image of a document and generates image data. For example, the document reader 130 includes a scanner device or the like including a device for converting optical information into an electric signal, such as a CIS (Contact Image Sensor) or a CCD (Charge Coupled Device).

For example, the document reader 130 reads a document placed on a placing table within the range set by a document size and outputs the read document as image data. The document may be set on the placing table or may be set in an ADF (Auto Document Feeder).

The image former 140 is a functional unit for forming image data on a recording medium (for example, a recording sheet). For example, the image former 140 feeds a recording sheet from the paper tray 1410 of FIG. 2, and ejects the sheet from a paper output tray 1420 after an image is formed on the surface of the recording sheet in the image former 140. The image former 140 includes, for example, a laser printer or the like using an electrophotographic method. In addition, usually one or more paper trays 1410 are included to accommodate the paper.

The displayer 150 displays various states of the image forming apparatus 10 and operation input states. For example, the displayer 150 includes an LCD (liquid crystal display), an organic EL panel, and an electronic paper using an electrophoretic method.

The operator 160 is a button, a switch, or the like that receives an operation input from the user. The operator 160 may be achieved by a hardware input device such as a switch or a keyboard, or a touch panel integrally formed with the displayer 150. In this case, the method for detecting an input on the touch panel may be any general detection method such as a resistive film type, an infrared type, an electromagnetic induction type, or a capacitive type. The operator 160 of the present embodiment includes a hardware input device and a touch panel of the displayer 150, and they can be operated respectively.

The network communicator 170 communicates with other apparatuses via a network NW. For example, the network communicator 170 includes an interface connectable to the network and is connected to other apparatuses via a wired/wireless LAN (Local Area Network) to communicate with one another. Image data may be transmitted and received from other apparatuses (for example, USB memory, etc.) by a USB (Universal Serial Bus) interface or the like.

The FAX communicator 180 is a functional unit for performing FAX communication. For example, the FAX communicator 180 transmits and receives image data (text data), as a document, with other FAX apparatuses, multifunction peripherals, computers, and the like via an INS line. The communication may be circuit-switched communication using an analog telephone line or ISDN line, packet communication, or communication using the Internet (for example, an Internet FAX). That is, as long as the received document is stored as image data and processed, the communication method does not matter.

The image forming apparatus 10 may further include necessary functions in addition to the above-described configuration. For example, a billing manager may be included, and a manager may be provided in such a manner that the image forming apparatus 10 can be used only when a fee is paid by the user.

### Functional Configuration of Chat Server

The chat server 20 illustrated in FIG. 4 includes a controller 200, a storage 220, and a network communicator 270. The chat server 20 provides a chat service to the terminal apparatus 30.

The controller 200 includes a chat processor 201, and functions in accordance with the control program 221 stored in the storage 220. In addition, the chat processor 201 functions as an AI, and responds with an appropriate chat text in accordance with the chat text received from the terminal apparatus 30. In this way, the chat server 20 has a function of performing automatic dialogue, and functions as a chatbot.

The storage 220 includes a control program 221, dialogue data 222, document image data 223, reception notification information 224, and registered user information 225. The control program 221 includes an automatic dialogue program. This program has a function of grasping the content through a dialogue (chat), and by doing so, it is possible to grasp instruction content and perform processing in accordance with the instruction content. The dialogue data 222 is dialogue data for performing chat processing, and is a chat text necessary for dialogue processing, including the chat text learned by the AI. The document image data 223 is a file of document image data in a FAX reception notification. The reception notification information 224 is FAX reception notification information transmitted from the image forming apparatus 10. The registered user information 225 is the registration information among the parties performing the chat. The user performs the setting process of registering the image forming apparatus 10 of a chat partner from the terminal apparatus 30, and the notification destination information of the parties performing the chat is stored as the registered user information 225.

The network communicator 270 is the same as the network communicator 170 of the image forming apparatus 10 and its description is omitted.

### Functional Configuration of Terminal Apparatus

The terminal apparatus 30 illustrated in FIG. 5 is, for example, a smart phone, a notebook PC, a tablet, or the like, and includes a controller 300, a storage 320, a displayer 350, an operator 360, and a network communicator 370. A chat application is installed on the terminal apparatus 30, and the FAX reception notification information and the received document image information are notified from the chat server 20 with the use of the API of the chat application.

The controller 300 is a functional unit for controlling the entire terminal apparatus 30. The controller 300 implements various functions by reading out and executing a control program 321 stored in the storage 320, and includes one or more computing devices (for example, CPUs (Central Processing Units)) or the like. The control program 321 also incorporates an interactive application to enable a chat with the chat server 20.

The storage 320 includes the control program 321, document image information 322, and reception notification information 323. The control program 321 is a program for executing each function and incorporates a chat application to enable a chat with the chat server 20. The document image information 322 is a file of the document image transmitted as a FAX reception notification. The reception notification information 323 is FAX reception notification information transmitted from the image forming apparatus 10.

The displayer 350 displays various states of the terminal apparatus 30 and operation input states. For example, the displayer 350 includes an LCD (liquid crystal display), an organic EL panel, or the like.

The operator 360 is a button, a switch, or the like that receives an operation input from the user. The operator 160 may be achieved by a hardware input device such as a switch or a keyboard, or a touch panel integrally formed with the displayer 150. In this case, a method for detecting an input on the touch panel may be any general detection method such as a resistive film type, an infrared type, an electromagnetic induction type, or a capacitive type.

The network communicator 370 is the same as the network communicator 170 of the image forming apparatus 10 and its description is omitted.

### File Server

The file server 40 illustrated in FIG. 6 is a server that stores data as a shared file on the network, and can be accessed via the network. In this system, the files of all pages of the document image received by FAX are stored, and by notifying this URL, it is possible to access the terminal apparatus 30 from the outside.

The file server 40 includes a controller 400, a storage 420, and a network communicator 470.

The controller 400 functions in accordance with a control program 421 stored in the storage 420.

The storage 420 includes the control program 421, and document image data 422.

The document image data 422 is a file of all pages of the document image transmitted from the image forming apparatus 10.

The network communicator 470 is the same as the network communicator 170 of the image forming apparatus 10 and its description is omitted.

### Fax Reception Notification Process

Hereinafter, the process of notifying the terminal apparatus 30 of the reception when the image forming apparatus 10 receives a FAX from an other FAX apparatus 50 will be described.

First, the reception notification process of the image forming apparatus 10 will be described with reference to the flowcharts illustrated in FIGS. 7 and 8.

The image forming apparatus 10 receives a FAX from the other FAX apparatus 50 via the FAX communicator 180, and the FAX processor 102 performs a FAX reception process, acquires FAX reception information, and stores same in the storage 120 (step S11). The information generator 104 determines whether there is the reception notification setting information 124 in the storage 120 (step S12). If there is the reception notification setting information 124, the information generator 104 proceeds to step S13, and if there is no reception notification setting information 124, the information generator 104 ends the process.

In step S13, the information generator 104 generates reception notification information in accordance with the reception notification setting information 124 in the storage 120. The information notification processor 105 transmits reception information from the network communicator 170, to the chat server 20 that functions as a chatbot, via the network on the basis of the notification setting information (step S14). Next, the information notification processor 105 determines the reception notification setting information 124 related to the image transfer (step S15), proceeds to step S16 if the image transfer is enabled, or ends the process if the image transfer is disabled.

The settings for image transfer are made in advance for the image forming apparatus 10. The user selects “chat application notification setting when receiving FAX” from respective setting items by the operator 160, and causes the displayer 150 to display the setting screen illustrated in FIG. 10. In the “image transfer” item on the setting screen, the page setting for image transfer is performed by selecting one of “first page”, “specified page”, and “all pages” on a page setting display 151. Although not illustrated, if the specified page is selected, a screen for selecting a page is displayed, and a page such as “1st page, 2nd page” is specified. In this way, the page setting is performed in advance in such a manner that a part of the document image will be transferred as the document image information.

For the setting of “transfer all pages”, “transmit file to application” or “store in server and notify URL” is selected in a transmission selection display 152.

FIG. 8 is a flowchart illustrating the image transfer process of step S16. The information generator 104 branches the process in accordance with the number of transmission pages in the reception notification setting information 124 in the storage 120 (step S21).

If only the first page is to be transmitted, the information generator 104 proceeds to step S22, makes a file of the first page of the received document image data 122 stored in the storage 120, and proceeds to step S26. If only the specified page (for example, the 1st and 2nd pages) is to be transmitted, the information generator 104 proceeds to step S23, makes a file of the specified page of the document image data 122 stored in the storage 120, and proceeds to step S26. In this way, the file of part of the document image data of all pages is made and used as the document image information.

If all pages are to be transmitted, the information generator 104 proceeds to step S24, makes a file of all pages of the document image data 122 stored in the storage 120, and checks the notification method in the setting information (step S25). If the file is to be transmitted to the chat server 20, the information generator 104 proceeds to step S26. If a URL of a destination where the file is saved is to be notified to the chat server 20, the information generator 104 proceeds to step S27.

In step S26, the information notification processor 105 transmits the file of the document image to be transmitted to the chat server 20 via the network communicator 170.

If a URL is to be transmitted, in step S27, the information generator 104 stores the file in the file server 40 and uses the URL as the document image information. Then, the information notification processor 105 transmits the URL of the destination where the information is stored to the chat server 20 (step S28).

FIG. 9 is a flowchart illustrating the processing content of the chat server 20. If there is information specified for transfer to the terminal apparatus 30 as the reception notification information from the image forming apparatus 10 (step S31), the chat processor 201 of the controller 200 of the chat server 20 proceeds to step S32, and if there is no transfer information, that chat processor 201 ends the process.

In step S32, the chat processor 201 of the chat server 20 retrieves the registered user information of the transfer destination from the registered user information 225 in the storage 220 (step S32) and transmits the reception notification information to a registered user with the use of the chat application (step S33).

As illustrated in FIG. 11, the terminal apparatus 30 that has received a FAX displays the reception notification screen of the chat application on the displayer 350. The reception notification information is displayed on a message 601 and further on a message 602 adjacent to and below the message 601, a received image icon 603 is displayed as the received document image. When the user touches this icon, the image file of the document is opened and the transmitted FAX document is displayed. In a case where the document image information is an URL, the URL of a destination where the file is saved is displayed in the message 602 instead of the received image icon 603.

The file of the document image data of all pages has been stored in the file server 40. However, the file may be stored in the chat server 20.

In this way, the user can receive the FAX reception notification by the terminal apparatus 30 through the chat application, and thus the FAX notification is given even when the user is away from the apparatus, and the user can immediately know that he/she has received a FAX. Moreover, the chat application is easy to use and easy to operate, and also easy to operate in other processes.

### Variation of First Embodiment

Next, a variation of the first embodiment of the present invention will be described with reference to the accompanying drawings.

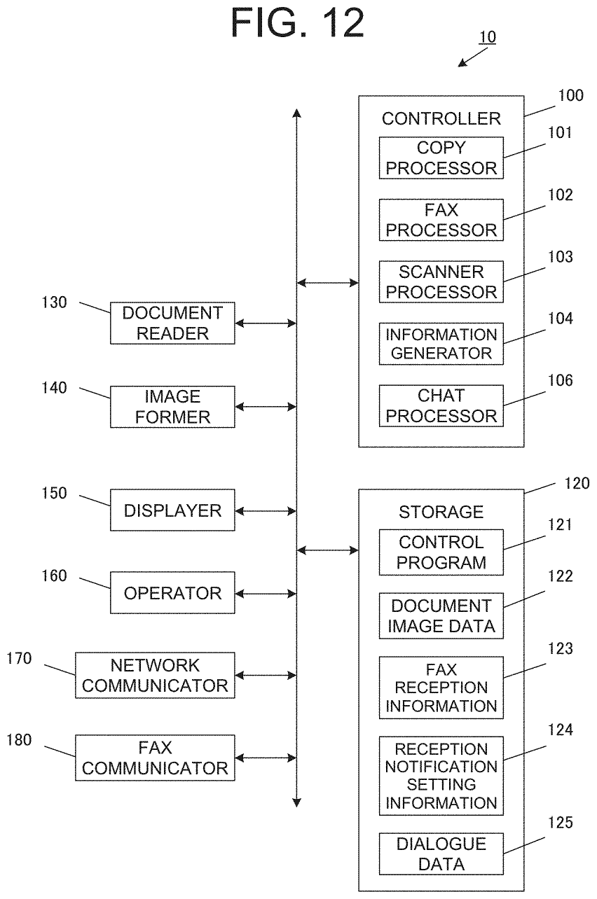

FIG. 12 is a block diagram illustrating a configuration of an image forming apparatus according to a variation of the first embodiment of the present invention.

### Summary

In the first embodiment, the chat server 20 functions as a chatbot. However, in this variation, the image forming apparatus 10 has the function of the chatbot. Therefore, the chat server is not required, and the image forming apparatus has the function of a chat server.

### Functional Configuration of Image Forming Apparatus

As illustrated in FIG. 12, the basic configuration is almost the same as that of the image forming apparatus of FIG. 3, but the following points are different. The controller 100 incudes a chat processor 106 as an alternative to the information notification processor 105. In addition, dialogue data 125 necessary for a chat is added to the storage 120. In this way, since the image forming apparatus 10 has a function as a chatbot, a chat server is not required.

Therefore, it is not necessary to perform processing of “transmit to chat server” (steps S14, S26, and S28) in FIGS. 7 and 8, and the transfer notification process to the terminal apparatus 30 in FIG. 9 is performed by the image forming apparatus.

### Second Embodiment

Next, a second embodiment of the present invention will be described with reference to the accompanying drawings.

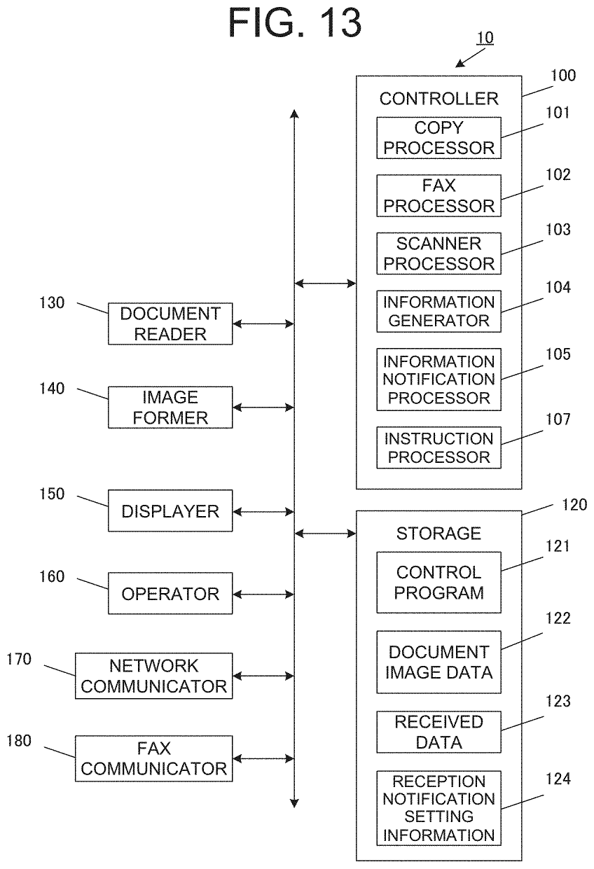

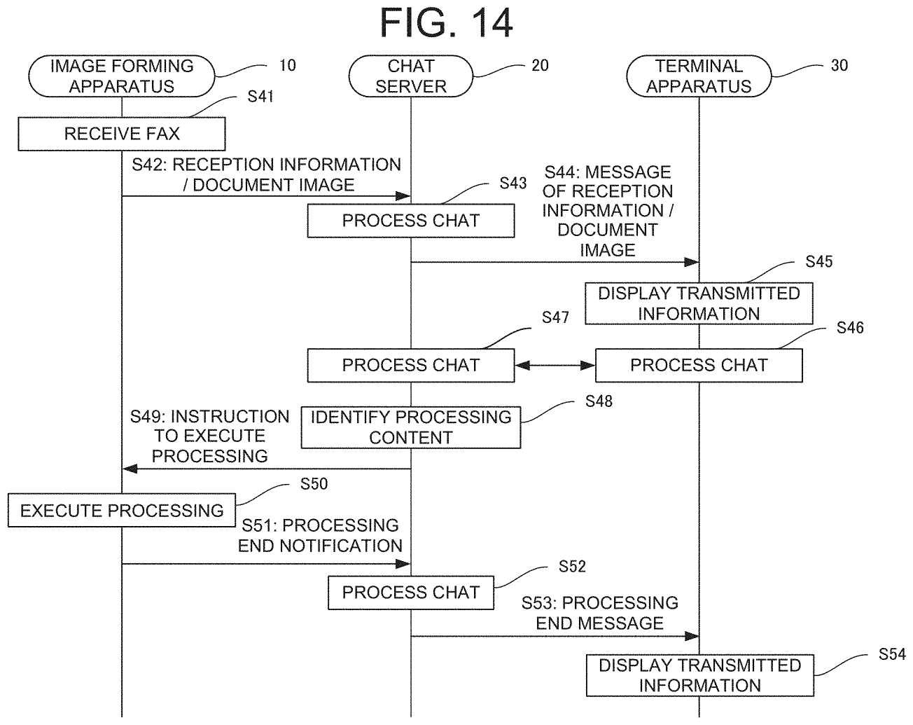

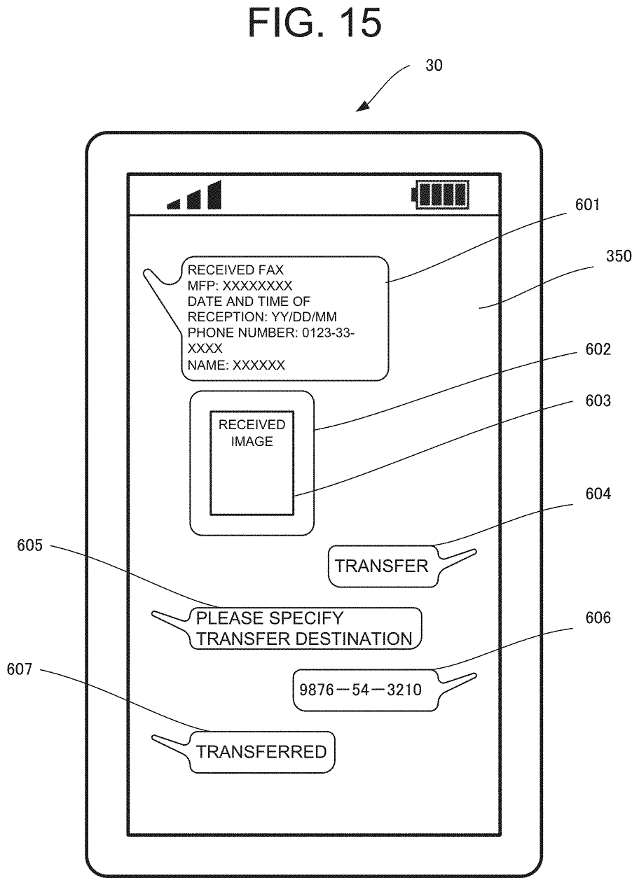

FIG. 13 is a block diagram illustrating a configuration of an image forming apparatus according to a second embodiment of the present invention. FIG. 14 is a sequence diagram illustrating a procedure of a reception notification and a processing instruction to the image forming apparatus. FIG. 15 is a diagram illustrating a display screen of a processing instruction to the image forming apparatus of a terminal apparatus according to the second embodiment.

### Summary

In the second embodiment, the terminal apparatus 30 that has received the reception notification information instructs the image forming apparatus 10 to perform processing through a chat application.

Since the FAX reception notification system and the apparatuses constituting the FAX reception notification system have the same configuration as that of the first embodiment except for the image forming apparatus, the description thereof will be omitted.

### Functional Configuration of Image Forming Apparatus

As illustrated in FIG. 13, the image forming apparatus 10 differs from the image forming apparatus of the first embodiment in that an instruction processor 107 is added to the controller 100.

The instruction processor 107 has a function of executing an instruction by the chat transmitted from the terminal apparatus 30 via the chat server 20. Other than this part, the configuration is the same as that of the first embodiment, and thus the description thereof is omitted.

### Processing Instruction According to Fax Reception Notification Process

As illustrated in FIG. 14, when receiving a FAX (step S41), the image forming apparatus 10 which is an MFP performs the processes of FIGS. 7 and 8, and transmits the FAX reception information and the document image information to the chat server 20 (step S42). The chat server 20 performs the process by the chat processor 201 in FIG. 9 (step S43), and transmits the FAX reception notification information and the document image information to the terminal apparatus 30 (step S44).

The terminal apparatus 30 uses the chat application to display the reception notification information and document image information that have been transmitted, as illustrated in FIG. 15 (step S45). In the displayer 350 of the terminal apparatus 30, the reception notification information is displayed on the message 601 and further on a message 602 adjacent to and below the message 601, the received image icon 603 is displayed as the received document image.

The user may want to confirm the reception information and the document image and cause the image forming apparatus 10 to perform processing. In this case, an instruction can be transmitted to the image forming apparatus with the use of the chat application. In doing so, the chat server 20 functions as a chatbot, and the chat processor 201 performs a chat interaction with the terminal apparatus 30 on the basis of the dialogue data 222 in the storage 220 (steps S46 and S47), and identifies the processing content instructed by the terminal apparatus 30 (step S48). The history of the interaction is displayed as a message on the terminal apparatus 30. The chat server 20 transmits the identified processing instruction to the image forming apparatus 10 (step S49), and the instruction processor 107 of the image forming apparatus 10 executes the processing (step S50). When the processing ends, the processing end notification is transmitted to the chat server 20 (step S51). By the processing of the chat processor 201 (step S52), the chat server 20 transmits the processing end notification to the terminal apparatus 30 as a message (step S53). The terminal apparatus 30 displays a message on the displayer 350 by the chat application (step S54).

FIG. 15 illustrates messages on the display screen of the terminal apparatus 30, which are displayed by the process of steps S46 to S54. The user inputs the message “transfer” from the operator 360 of the terminal apparatus 30. This message 604 is displayed on the displayer 350 and is transmitted to the chat server 20. The chat processor 201 of the chat server 20 that received this recognizes the instruction of the transfer process from the text “transfer”, and determines that the instruction of “transfer destination” is necessary. Then, the chat processor 201 transmits the message “please specify transfer destination” to the terminal apparatus 30. The terminal apparatus 30 displays a message 605 “please specify transfer destination”. The user inputs a transfer destination phone number “9876-54-3210”. This phone number message 606 is displayed on the displayer 350 and is transmitted to the chat server 20. The chat server 20 transmits the transfer destination phone number and the transfer process instruction to the image forming apparatus 10. The instruction processor 107 of the image forming apparatus 10 executes the transfer process in accordance with the instruction.

The screen display illustrated in FIG. 15 illustrates the transfer process, but the instruction is not limited to this, and may be an instruction for processing such as printing or deleting.

In this way, even when the user is away from the image forming apparatus 10, the terminal apparatus 30 can issue a processing instruction to the image forming apparatus 10 with the use of the chat application. The chat server 20 functions as a chatbot, and thus it is possible to identify the processing content by interacting with the user by the terminal apparatus 30 and to give an accurate instruction to the image forming apparatus 10. In addition, by using the chat application, it is possible for the user to give a processing instruction with a simple operation.

### Third Embodiment

Next, a third embodiment of the present invention will be described with reference to the accompanying drawings.

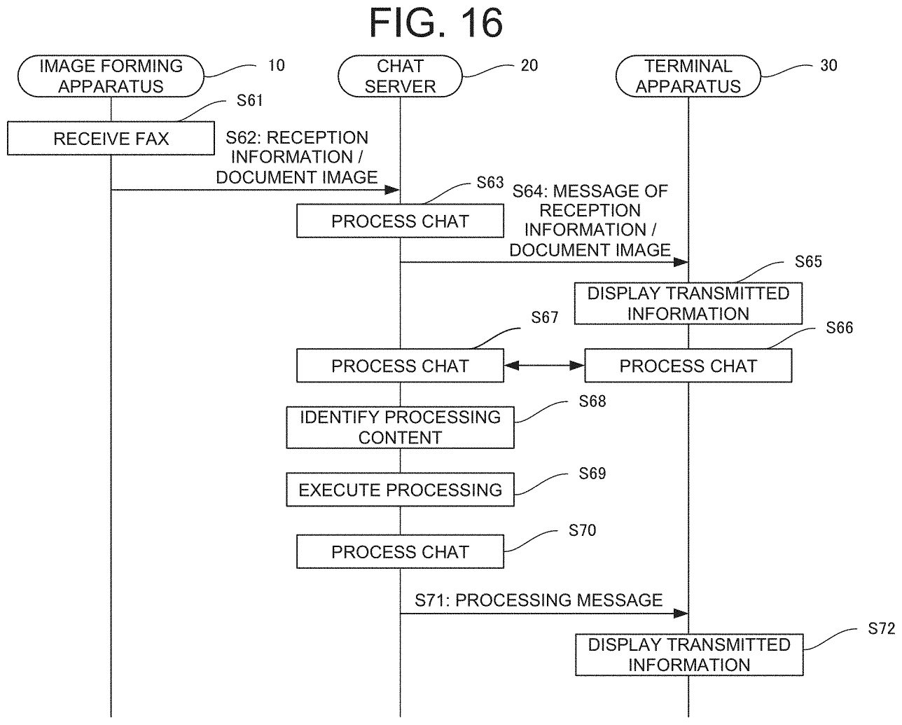

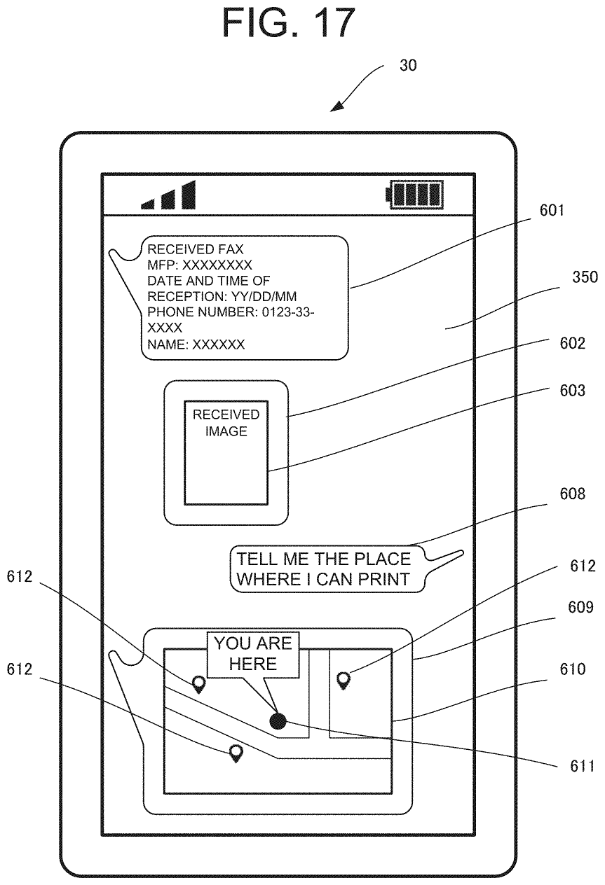

FIG. 16 is a sequence diagram illustrating a procedure of a reception notification and a processing instruction to the image forming apparatus according to the third embodiment. FIG. 17 is a diagram illustrating a display screen of a processing instruction to the image forming apparatus of a terminal apparatus according to the third embodiment.

### Summary

In the third embodiment, the terminal apparatus that has received the reception notification information instructs the chat server or an other server to perform processing through a chat application.

Since the FAX reception notification system and the apparatuses constituting the FAX reception notification system have the same configuration as that of the second embodiment, the description thereof will be omitted.

### Processing Instruction According to Fax Reception Notification Process

In the sequence diagram illustrated in FIG. 16, steps S61 to S65 are the same as steps S41 to S45 in FIG. 14. Suppose that the user wants to know a nearby MFP by looking at the FAX reception notification and the document image displayed on the displayer 350 of the terminal apparatus 30. Accordingly, as illustrated in FIG. 17, if the user inputs a message 608 “Tell me the place where I can print”, it will be transmitted to the chat server 20 and processed by the chat processor 201 (steps S66 and S67). If the instruction content is unclear, a further interaction is performed with the terminal apparatus 30, and the chat processor 201 identifies the processing content (step S68).

In this embodiment, the chat processor 201 can identify the processing content in the message 608 “Tell me the place where I can print”. Therefore, the chat server 20 obtains the position and map data of an MFP near the terminal apparatus 30 (step S69).

In this case, the chat server 20 acquires the position information of the terminal apparatus 30, and further uses an other server or the like to obtain the position and map data of the image forming apparatus 10 that can perform printing and exists at a position close to the terminal apparatus 30. With regard to the position information of the terminal apparatus 30, the terminal apparatus 30 includes a method for obtaining a position from GPS information, base station information, WiFi information, or the like, and thus the chat server 20 obtains the position by the method.

This is processed by the chat processor 201 (step S70), and the data is transmitted to the terminal apparatus 30 as a message (step S71). In the terminal apparatus 30, this information is displayed on the displayer 350 (S72). As illustrated in FIG. 17, the terminal apparatus 30 displays map information 610 as a message 609. In this map, a symbol 611 indicates the current position of the terminal apparatus 30, and a symbol 612 indicates the position of the image forming apparatus 10 that can perform printing.

In this way, even when the user is away from the image forming apparatus 10, the terminal apparatus 30 can issue a processing instruction to the image forming apparatus 10 with the use of the chat application. The chat server 20 functions as a chatbot, and thus it is possible to identify the processing content by interacting with the user by the terminal apparatus 30 and to give an accurate instruction to an apparatus other than the image forming apparatus 10. In addition, by using the chat application, it is possible for the user to give a processing instruction with a simple operation.

### Fourth Embodiment

Next, a fourth embodiment of the present invention will be described with reference to the accompanying drawings.

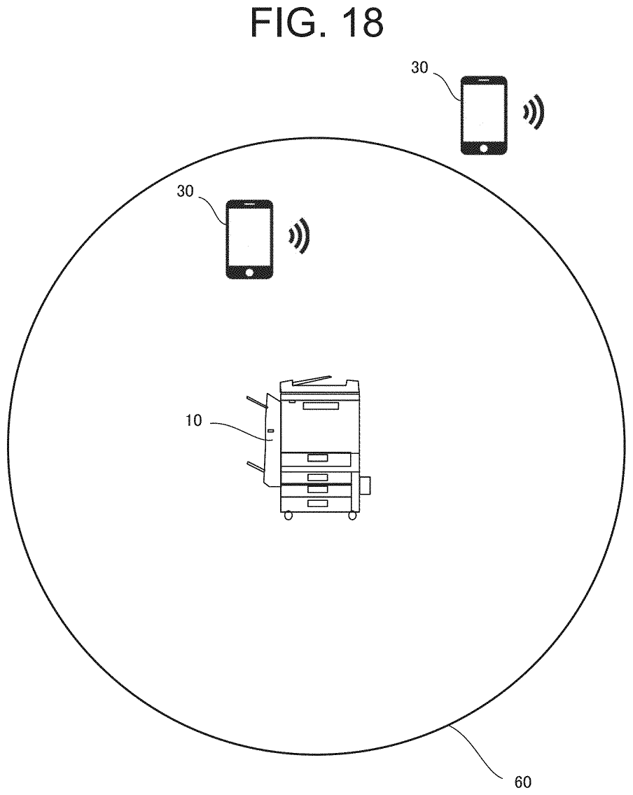

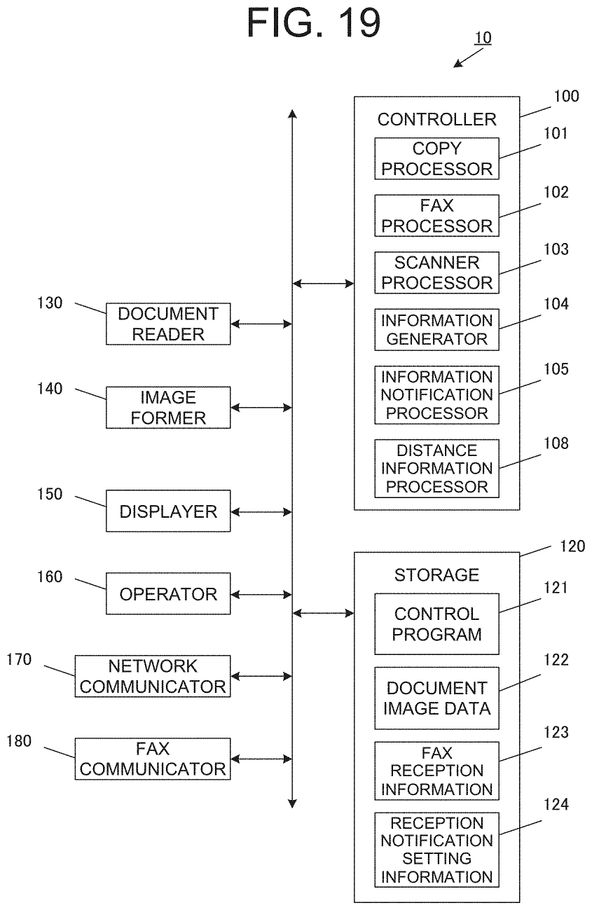

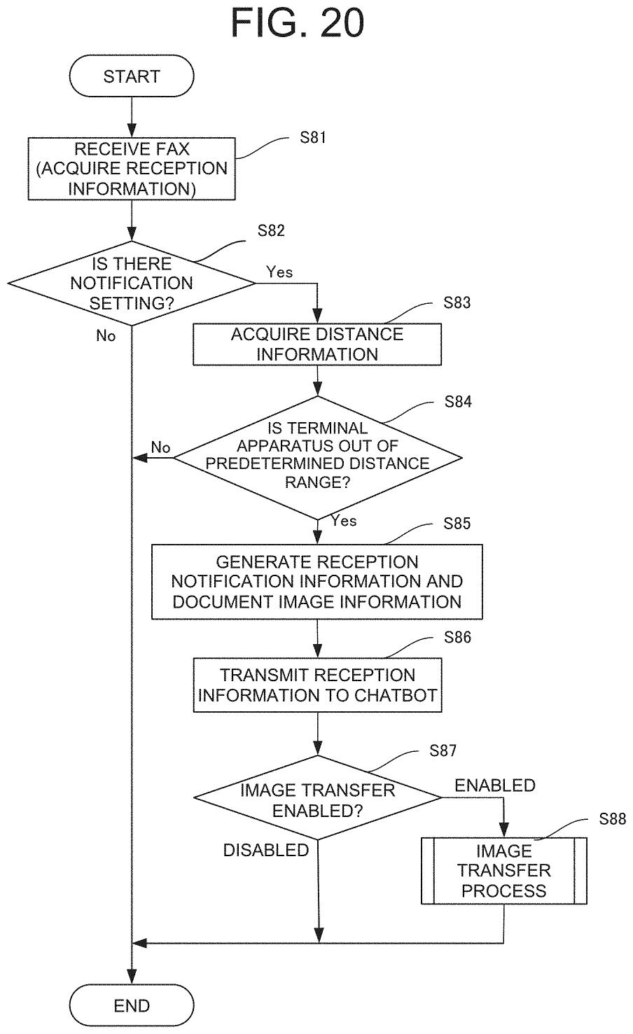

FIG. 18 is an explanatory diagram illustrating positions of an image forming apparatus and a terminal apparatus according to a fourth embodiment. FIG. 19 is a block diagram illustrating a configuration of the image forming apparatus. FIG. 20 is a flowchart illustrating a reception notification process.

### Summary

In the fourth embodiment, as illustrated in FIG. 18, when the terminal apparatus 30 is within a certain distance 60 from the image forming apparatus 10, the reception notification is not transmitted. This is because the terminal apparatus 30 is close to the image forming apparatus 10 for FAX reception and the reception processing can be performed by the image forming apparatus 10, and thus it is considered that the notification to the terminal apparatus 30 is not required. When the terminal apparatus 30 is outside the certain distance of 60 from the image forming apparatus 10, the terminal apparatus 30 is notified of the reception since the user is way from the image forming apparatus 10 and the processing by the image forming apparatus 10 cannot be performed directly by the user.

Since the FAX reception notification system and the apparatuses constituting the FAX reception notification system have the same configuration as that of the first embodiment except for the image forming apparatus, the description thereof will be omitted.

### Functional Configuration of Image Forming Apparatus

As illustrated in FIG. 19, the image forming apparatus 10 is obtained by adding a distance information processor 108 to the controller 100 of the image forming apparatus of the first embodiment of FIG. 3.

### Fax Reception Non-Notification Process

The flowchart illustrated in FIG. 20 is different from the flowchart in FIG. 7 in that steps S83 and S84 are inserted. Therefore, steps S81 to S82, S85 to S88 and steps S11 to S16 are processed in exactly the same way.

In step S83, the distance information processor 108 acquires the distance information between the image forming apparatus 10 and the terminal apparatus 30. There are various methods for measuring the distance in this case. The image forming apparatus and the terminal apparatus may include a measurer. For example, the distance between the image forming apparatus 10 and the terminal apparatus 30 may be obtained with the use of GPS information or position information using WiFi, Bluetooth, or the like. In step S84, the distance information processor 108 determines whether the terminal apparatus 30 is outside the certain distance 60 from the image forming apparatus 10.

If the image forming apparatus 10 and the terminal apparatus 30 are outside the certain distance, the distance information processor 108 proceeds to step S85 and transmits the reception information and the document image information to the terminal apparatus 30. If the image forming apparatus 10 and the terminal apparatus 30 are within the certain distance, the distance information processor 108 ends the process.

In this way, if the image forming apparatus 10 and the terminal apparatus 30 are within a certain distance, the FAX reception of the image forming apparatus 10 can be known without notifying the reception, and various processing can be performed by directly operating the image forming apparatus 10. On the other hand, if the distance is outside the certain distance, the user cannot directly operate the image forming apparatus 10. Thus, the reception is notified with the use of the chat application, and the user can thereby know the FAX reception. Furthermore, as illustrated in the second and third embodiments, it is also possible to instruct processing from the terminal apparatus 30 with the use of the chat application.

### Fifth Embodiment

Next, a fifth embodiment of the present invention will be described with reference to the accompanying drawings.

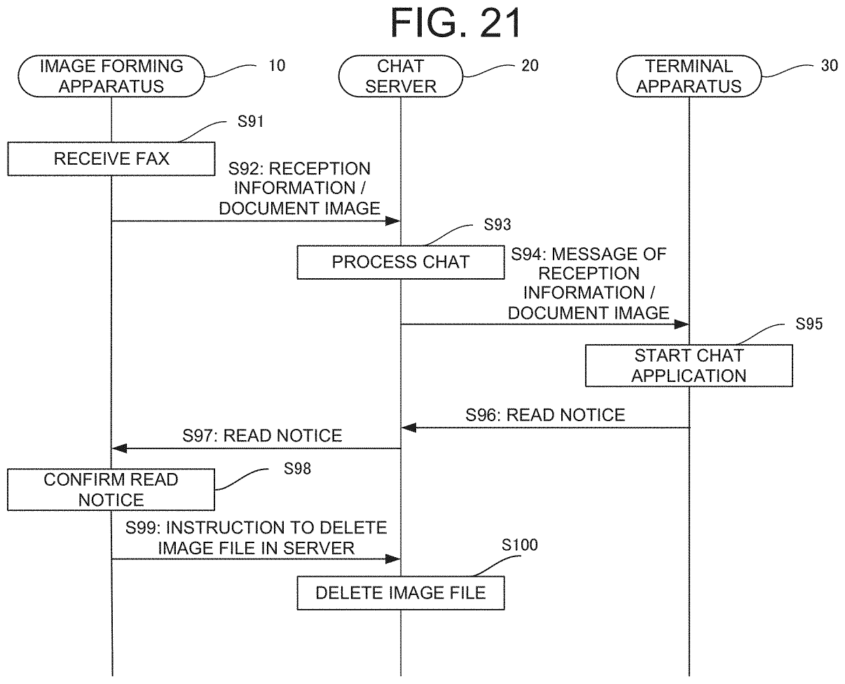

FIG. 21 is a sequence diagram illustrating a procedure of reception notification and deletion of document image data in the chat server 20 according to a fifth embodiment of the present invention.

### Summary

In the fifth embodiment, when the message of the reception notification information is read by the chat application of the terminal apparatus 30, the document image in the chat server 20 is deleted for the reason of security.

Since the FAX reception notification system and the apparatuses constituting the FAX reception notification system have the same configuration as that of the second embodiment, the description thereof will be omitted.

### Processing Instruction According to Fax Reception Notification Process

The processing of steps S91 to S94 illustrated in FIG. 21 is the same as the processing of steps S41 to S44 in FIG. 14. When the chat application of the terminal apparatus 30 is started by the user (step S95), a chat display screen opens. In doing so, the terminal apparatus 30 considers that the user has read the message content and transmits a read notice to the chat server 20 (step S96). Moreover, the chat server 20 transmits the read notice to the image forming apparatus 10 (step S97). When confirming the read notice (step S98), the image forming apparatus 10 transmits, to the chat server 20, an instruction to delete the document image data received by FAX this time and stored in the storage 220 of the chat server 20 (step S99). The chat server 20 deletes the instructed document image data (file) (step S100).

In this embodiment, the read notice is transmitted to the image forming apparatus 10 once, and the image forming apparatus 10 issues an instruction to delete the document image data received by FAX this time to the chat server 20, but the present invention is limited to this. The chat server 20 may delete the document image data when the chat server 20 receives the read notice.

In this way, when the message is already read in the terminal apparatus 30, the FAX document image data stored in the chat server 20 is automatically deleted, and thus the safety on security can be ensured.

The program that operates in the reception notification system according to the present invention may be a program that controls a CPU (Central Processing Unit) or the like (a program that causes a computer to function) so as to implement the functions of the above-described embodiments according to the present invention. In addition, the information handled by these apparatuses is temporarily stored in a RAM (Random Access Memory) during processing, and then stored in various ROMs such as a Flash ROM (Read Only Memory) and an HDD (Hard Disk Drive). The data is read, modified, and written by the CPU as needed. Moreover, the program for implementing the functions of each configuration is recorded in a computer-readable recording medium, and the program recorded in this recording medium may be read into a computer system and executed to perform processing of each unit. The “computer system” here shall include a hardware such as an OS and peripheral devices.

In addition, the “computer-readable recording medium” means a portable medium such as a flexible disk, a magneto-optical disk, a ROM, a CD-ROM, and a storage device such as a hard disk built in the computer system. Furthermore, the above-mentioned program may be for implementing some of the above-mentioned functions, or may be for implementing the above-mentioned functions in combination with a program already recorded in the computer system.

### REFERENCE SIGNS LIST

1 FAX reception notification system
10 image forming apparatus
20 chat server
30 terminal apparatus
40 file server
50 FAX apparatus
100 controller
102 FAX processor
104 information generator
105 information notification processor
106 chat processor
107 instruction processor
108 distance information processor
120 storage
121 control program
122 document image data
123 FAX reception information
124 reception notification setting information
125 dialogue data
170 network communicator
180 FAX communicator
200 controller
201 chat processor
220 storage
221 control program
222 dialogue data
223 document image data
224 reception notification information
225 registered user information
270 network communicator
300 controller
320 storage
321 control program
322 document image information
323 reception notification information
350 displayer
360 operator
370 network communicator

What is claimed is:

1. An image forming apparatus for notifying a terminal apparatus in a chat format via a chat server that a FAX has been received, the image forming apparatus comprising:
a FAX processor that receives a FAX and acquires reception information;
an information generator that generates reception notification information and document image information on a basis of the reception information; and
an information notification processor that transmits the reception notification information and the document image information to the chat server to notify the terminal apparatus.

2. The image forming apparatus according to claim 1, wherein the information notification processor transmits an instruction to delete document image information stored in the chat server when the terminal apparatus notifies that reception notification has been read.

3. An image forming apparatus for notifying a terminal apparatus in a chat format that a FAX has been received, the image forming apparatus comprising:
a FAX processor that receives a FAX and acquires reception information;
an information generator that generates reception notification information and document image information on a basis of the reception information; and
a chat processor that transmits the reception notification information and the document image information to the terminal apparatus as a message for a chat.

4. The image forming apparatus according to claim 1, wherein the reception notification information includes identification information of an apparatus that has received the FAX and received other party information.

5. The image forming apparatus according to claim 1, wherein the document image information is a part of a preset document image.

6. The image forming apparatus according to claim 1, wherein the document image information is a URL indicating a destination where a document image file is saved.

7. The image forming apparatus according to claim 1, comprising a distance information processor that acquires information on a distance from the terminal apparatus to determine whether the terminal apparatus is present within a certain distance,
wherein the information notification processor does not perform FAX reception notification when the terminal apparatus is present within a certain distance, on a basis of the information on the distance.

8. The image forming apparatus according to claim 1, comprising an instruction processor that executes processing in accordance with a processing instruction when the processing instruction is transmitted from the terminal apparatus.

9. A reception notification method for notifying a terminal apparatus in a chat format via a chat server that an image forming apparatus has received a FAX, the reception notification method comprising:
receiving a FAX and acquiring reception information;
generating reception notification information and document image information on a basis of the reception information; and
transmitting the reception notification information and the document image information to the chat server to notify the terminal apparatus.

10. A reception notification method for notifying a terminal apparatus in a chat format that an image forming apparatus has received a FAX, the reception notification method comprising:
receiving a FAX and acquiring reception information;
generating reception notification information and document image information on a basis of the reception information; and
transmitting the reception notification information and the document image information to the terminal apparatus as a message for a chat.
